(19) United States
(12) Patent Application Publication
(10) Pub. No.: US 2012/0296832 A1
(43) Pub. Date: Nov. 22, 2012

(54) DEFINING AGREEMENTS USING COLLABORATIVE COMMUNICATIONS

(75) Inventors: JOERG BERINGER, Los Altos, CA (US); Pen-Fan Sun, San Francisco, CA (US)

(73) Assignee: SAP AG, Palo Alto, CA (US)

(21) Appl. No.: 13/108,390

(22) Filed: May 16, 2011

(51) Int. Cl. G06Q 30/00

(52) U.S. Cl. 705/80

(57) ABSTRACT

An agreement object comprising a plurality of terms for negotiation among two or more users is concurrently presented with an unstructured conversation among at least two users. Thereafter, data characterizing terms for which an agreement has been reached is received resulting in the agreement object being updated to reflect the terms for which an agreement has been reached. An agreement based on the agreement object is then finalized once an agreement has been reached for all of the terms. Related apparatus, systems, techniques and articles are also described.

### TECHNICAL FIELD

The subject matter described herein relates to systems, methods, and graphical user interfaces for defining and negotiating agreements using collaborative communications such as messaging, e-mail, and web-conferencing and by using contextual information relating to participating users.

### BACKGROUND

Collaboration technologies are typically designed and engineered in a generic way without having the context and the outcome of a collaboration in mind. For example, a chat service, while enabling the communication between one or multiple people, does not have any context as to why certain users have connected and exchanged information. As a result, any outcomes resulting from such communications over such services must be manually transferred to a separate application or module. Moreover, due to the lack understanding the framing context for such communications, the system is not able to provide contextual information facilitating the connection.

### SUMMARY

In one aspect, an agreement object comprising a plurality of terms for negotiation among two or more users is concurrently presented with an unstructured conversation among at least two users. Thereafter, data characterizing terms for which an agreement has been reached is received resulting in the agreement object being updated to reflect the terms for which an agreement has been reached. An agreement based on the agreement object can then be finalized after an agreement has been reached for each of the plurality of terms.

The presented agreement object can comprise a plurality of graphical user interface elements which, when activated, generate the received data characterizing terms for which an agreement has been reached.

At least a portion of the unstructured conversation can be parsed to associate the unstructured conversation with the agreement object, wherein the agreement object is presented in response to this association. The parsing can use a variety of technologies including, for example, Speech Act Theory, to associate the conversation with the agreement object. In addition or in the alternative, at least a portion of the unstructured conversation can be parsed to characterize terms for which an agreement has been reached. This parsing can use a variety of technologies including, for example, Speech Act Theory, to characterize the terms for which an agreement has been reached.

The agreement object can be one of a plurality of agreement templates made available to a user via a graphical user interface that the user selects. The plurality of agreement templates made available to the user can comprise be based on contextual information such as agreement templates historically used by the user. The user can have a pre-defined role such that the plurality of available agreement templates made available to the user comprise agreement templates associated with the pre-defined role. The user can have a pre-defined access level such that the plurality of available agreement templates made available to the user comprise agreement templates associated with the pre-defined access level.

The unstructured conversation can comprises one or more of: messaging, e-mail communications, videoconferencing, and web conferencing.

Finalizing the agreement can comprise storing data characterizing values for each of the terms in a repository, displaying data characterizing values for each of the terms in a repository, and/or transmitting the agreement to at least one entity for approval.

One or more additional users can be added to the conversation to seek approval of at least one of the terms or to obtain input regarding at least one of the terms. The graphical user interface can comprise at least one contact graphical user interface element, which when activated, adds at least one additional user to the conversation. The graphical user interface can comprise at least one information graphical user interface element, which when activated, concurrently displays additional information associated with one or more of the users and/or the agreement object. In addition, there can be a plurality of categories of terms and each category has a corresponding category graphical user interface element, which when activated, causes associated terms to be displayed in the agreement object.

In another aspect, an unstructured electronic conversation between two or more users is parsed, using a speech recognition algorithm, to identify an agreement object. The agreement object comprises a plurality of terms for negotiation among two or more of the users. Thereafter, user-generated input is received via a graphical user interface from at least one of the users defining a value for at least one of the plurality of terms. An agreement is then generated based on the user-generated input and the agreement object and the agreement is persisted.

In a further aspect, a graphical user interface is rendered that concurrently displays a conversations panel and an agreement object. The conversations panel displays communications between two or more users. The agreement object specifies a plurality of terms forming part of an agreement and comprising a plurality of graphical user interface elements associated with the plurality of terms which, when activated, cause values associated with the terms to change. User generated input is received via the graphical user interface from at least one of the users activating at least one of the graphical user interface elements and changing at least one value. An agreement is then generated based on this input and the agreement object.

In still a further aspect, an agreement object is instantiated that comprises a plurality of terms for negotiation among two or more users. The agreement object can be instantiated and/or initial values for terms can be populated based on contextual information associated with at least one user. Thereafter, data characterizing terms for which an agreement has been reached can be received (by, for example, parsing an unstructured conversation among the two or more users, etc.). This data results in the agreement object being updated to reflect the terms for which an agreement has been reached. Subsequently, an agreement based on the agreement object can be finalized when agreement has been reached for each of the plurality of terms.

Articles of manufacture are also described that comprise computer executable instructions permanently stored on computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein. Methods described herein can be implemented by one or more data processors forming part of a single computing system or distributed among two or more computing systems.

The subject matter described herein provides many advantages. For example, the current subject matter allows for goal and/or result oriented communications amongst individuals. In particular, the current subject matter allows for agreements to be defined and confirmed based on unstructured conversations between individuals/entities. In addition, by embedding structured tools/forms into an unstructured conversation, the agreement between two people can be informally or formally captured. Such a tool can serve to record the agreements or service level agreement, the accepted offer, the formal approval, or virtually any consensus about certain conditions. Moreover, by combining both qualities (unstructured ad-hoc conversation and shared semi-synchronous tool), the tool can help to set context for a conversation and to capture the outcome of that conversation. The other way around, the conversation capability helps to reduce the design of the tool to just capturing the agreed facts instead of sending different proposals back and forth.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating the generation of an agreement as part of an unstructured conversation between two or more users;

FIG. 2 is a workflow diagram illustrating the initiation, negotiation, and implementation of an agreement using an agreement object;

FIG. 3 is a first view of a graphical user interface illustrating an unstructured conversation;

FIG. 4 is a second view of graphical user interface including an unstructured conversation and an agreement object; and

FIG. 5 is a third view of graphical user interface rendering an unstructured conversation, an agreement object, and stakeholder network related to the agreement object.

### Like reference symbols in the various drawings indicate like elements.

### DETAILED DESCRIPTION

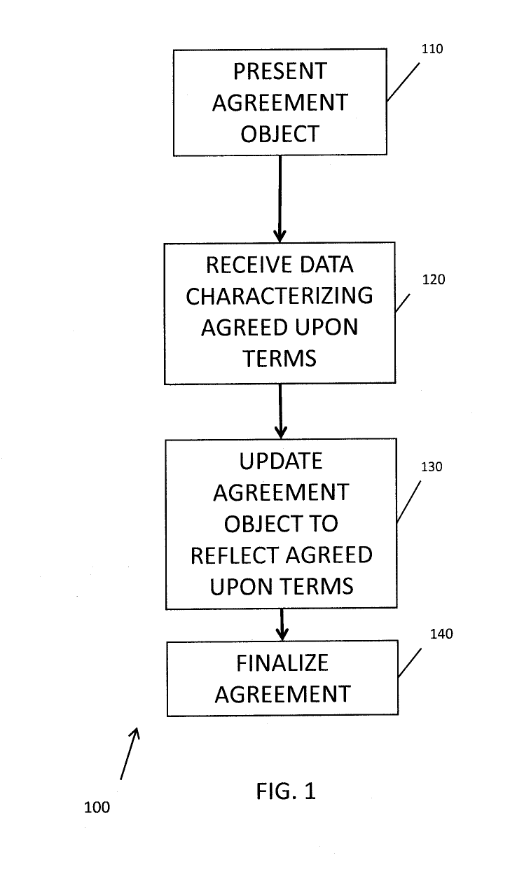

FIG. 1 is a process flow diagram illustrating a method 100 in which, at 110, an agreement object comprising a plurality of terms for negotiation among two or more of the users is concurrently displayed with an unstructured conversation among at least two users. Thereafter, at 120, data characterizing terms for which an agreement has been reached is received. The agreement object, at 130, is updated to reflect the terms for which an agreement has been reached. An agreement, at 140, is then finalized based on the agreement object when an agreement has been reached for each of the plurality of terms.

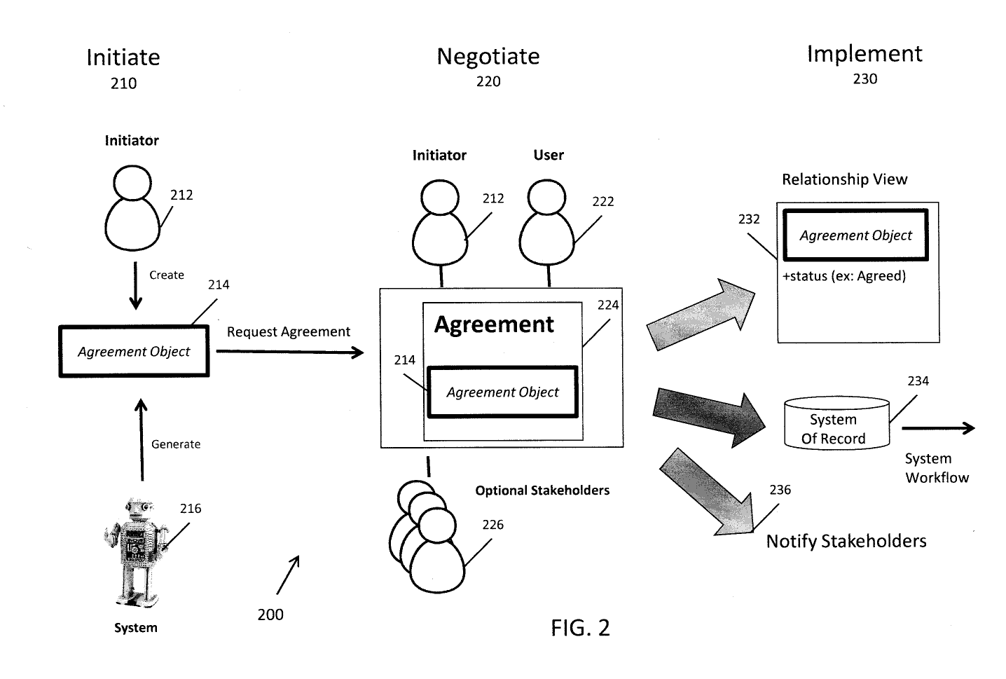

FIG. 2 is a diagram 200 illustrating a workflow that involves three main stages: initiate 210, negotiate 220, and implement 230. In the initiate stage 210, an initiator 212 (which can be an individual or other entity such as a group of individuals, etc.) creates or otherwise accesses an agreement object 214 from a system 216 (e.g., a data repository, a remote server, etc.). The agreement object 214 provides at least one term which must be negotiated in order to form an agreement. In some cases, the agreement object 214 can include pre-populated terms (which can be generic for all users or specifically tailored to the user or users having similar roles, access levels, and/or functions).

Subsequently, in the negotiate stage 220, the initiator 212 interacts with at least one second user 222 via a collaborative communications protocol such as messaging, e-mail, web conferencing or the like. Through such collaborative communications, the terms of the agreement object 214 are negotiated in an effort to reach a completed agreement 224. In some cases, the negotiation process can involve one or more optional stakeholders 226. Such optional stakeholders can be requested, for example, to give an opinion regarding one or more of the terms, approve one or more of the terms and the like. One or more views 232 of the completed agreement can be provided to the various participants (initiator 212, second user 222, optional stakeholders 226, etc.) in the implement stage 230. These views 232 can provide a graphical representation of one or more of the terms of the agreement 224 and can be updated when tasks associated with such terms are completed and/or when terms are subsequently modified. In addition, the agreement 224 can be stored in a data repository 234 and/or transmitted to various stakeholders 236.

As referenced in FIG. 2, the agreement object 214 can define a wide variety of relationships provided that at least one term needs to be negotiated/agreed upon in order to complete the agreement 224. Specific use case examples include: (i) requesting from someone to perform a task results in a service level agreement, (ii) negotiating conditions/price/etc results in accepting or rejecting aspects of the offer, (iii) planning performance of an direct report by setting objectives, (iv) clarifying missing information that is required to fully qualify a system entry, and (v) getting consensus about the availability and costs of a resource.

Categories of agreement objects include resource agreements such as service level agreements, project assignments, staffing commitments, leave requests, and task completion; cost-based agreements such as trip requests, discounts on goods or services, purchase requests, head count allocation, budget transfer, and sponsorship; goal agreements can include performance goals, development goals, project goals, and customer engagement goals; authorization agreements can include work from home request, visit customers, attend event, and posts regarding specified topics; and choice/decision agreements such as whether to hire a candidate, vendor selection, course of actions to take, and event date/location.

The workflow 200 of FIG. 2 can be implemented via a framework that captures the outcome of a communications between the initiator 212 and the second user 222 by integrating tools such as small, widget-like forms into the unstructured conversation context to represent and capture the outcome. In come cases, the conversation can be parsed or otherwise analyzed using a speech recognition technique such as Speech-Act theory in order to allow the various participants to communicate in a less formal manner. For example, the speech recognition technique can be utilized in order for the initiator to select the agreement object 214. Similarly, speech recognition techniques can be used to capture agreement on specific negotiated terms that form part of the completed agreement 224. In addition, the communications service (e.g., chat service, etc.) can be trained to extract semantics from the text (text analytics) to recognize key terms or parameters that are part of the tool and pre-fill the agreement object 214 with such recognized content. Whether or not speech recognition techniques are employed, the framework's embedded tool allows for the capture of the essential outcome of a conversation. The tool helps to the participants to stay focused and extract structured information from an unstructured discussion between the initiator 212 and the second party 222, or two negotiating parties.

Various types of contextual information can be used to identify/select the appropriate agreement object and/or to populate the agreement object 214. More specifically, agreement objects 214 can be derived and/or updated from an unstructured (informal) conversation between two or more parties and/or from any other existing contextual information. In addition, agreement objects 214 themselves can be part of the context of a 1:1 work relationship context comprising, for example, all past and pending agreements between two people and/or the respective roles of the two people (employee/manager, etc.) (and such relationship information can form part of the contextual information). Other contextual information such as the names of the users, contact information, relationship, and the like can also be added to the agreement object 214. Similarly, data relating to ongoing tasks and/or topics for a particular user can be used to identify/populate the agreement object 214.

In some implementations, data captured by the tool as the result of the conversations can be linked to an application context such as business logic, analytics, and personal project or task management. Such application context can be used to identify the agreement object (or a plurality of agreement templates) and/or term values for the agreement object 214.

By having an understanding of the desired outcome of the discussion, the tool can also propose stakeholders relevant to the discussion. This proposal can be based on one or more of the initiator 212, the second user 222, the stakeholders 226 and the agreement object 214. For example, when negotiating the allocation of a people resource, the tool can suggest the direct manager and second level manager of that resource to be included in the discussion and sign-off the conditions described in the tool. The content in the tool becomes the agreement 224 between these stakeholders and can be tracked with respect to fulfillment or revised it conditions change.

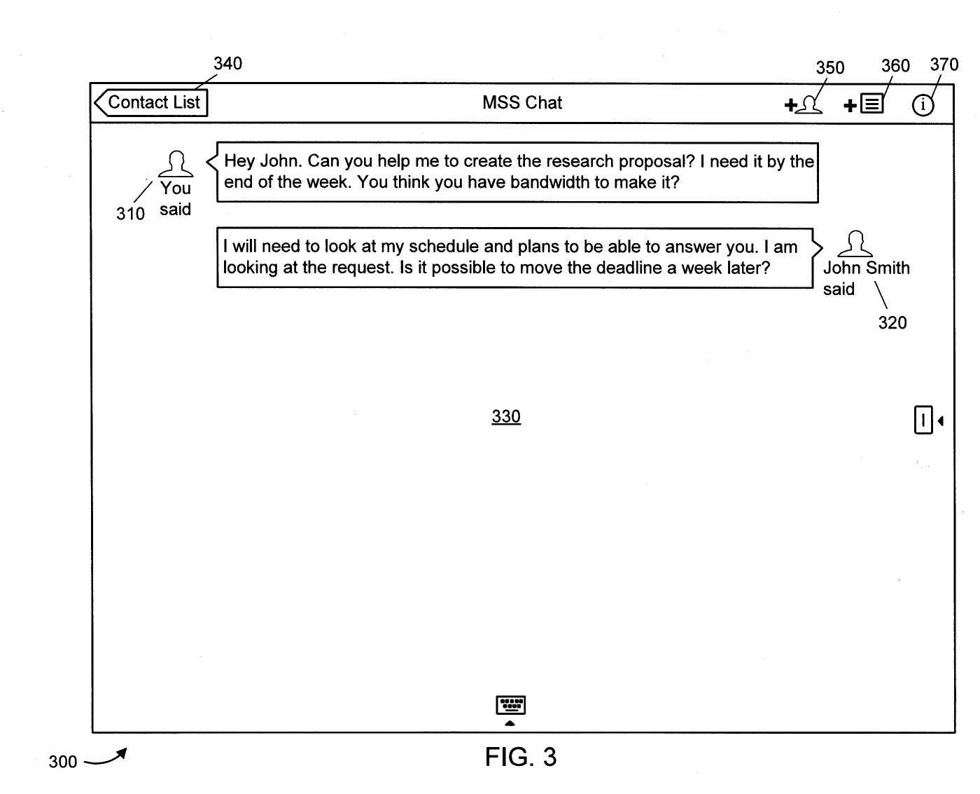

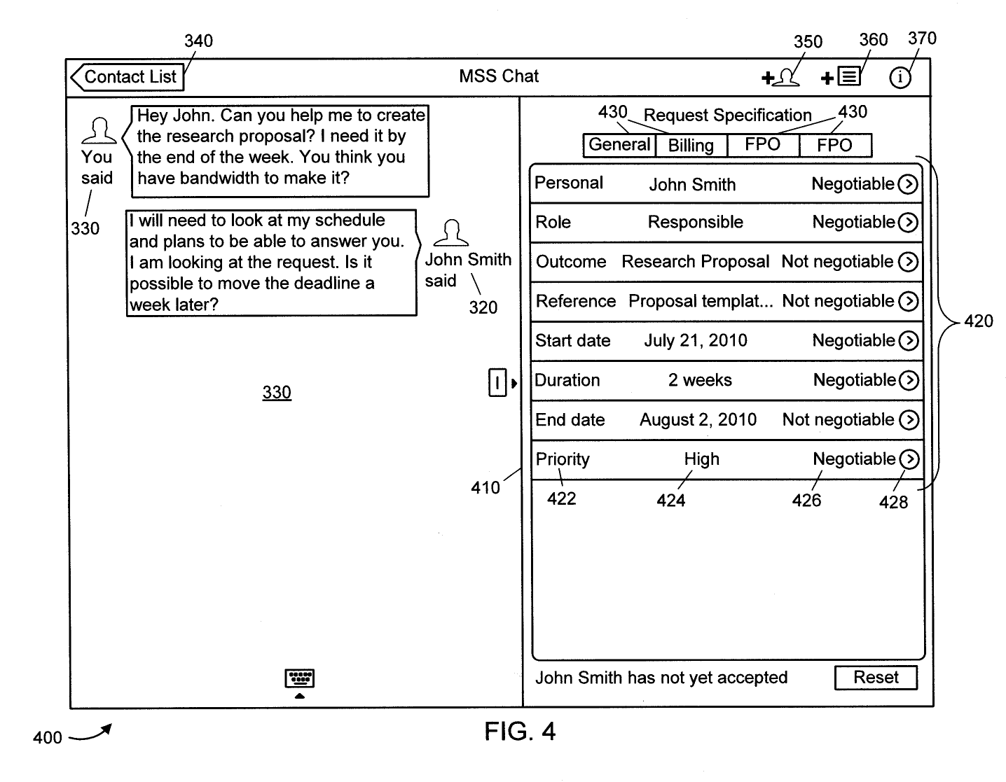

FIG. 3 is a view 300 of a graphical user interface in which a first user 310 is communicating with a second user 320 within a conversation panel 330. While such communications are shown as chat, it will be appreciated that the communications can take any form of electronic communication between two or more users. As part of the communication between the first and second users 310, 320, the users agreement to create a research proposal (by specifying the relevant terms). This research proposal will be based on an agreement object 420 (shown in FIG. 4). The graphical user interface also includes graphical user interface elements contacts 340, add people 350, add agreement objects 360, and information retrieval 370. The contacts element 340 and/or the add people 350 element can be used to add further users to the conversation in the conversation panel 330 and/or they can be used to add users for negotiation of the research proposal terms. The add agreement object element 360 can be selected by one or both of the first and second users 310, 320. Activating this add agreement object element 360 can cause a list of two or more agreement templates to be displayed so that the requesting user 310, 320 can select one such agreement template. Lastly, the information retrieval element 370 can be used to obtain information that might be complementary to the research proposal (i.e., the agreement) such as documents and the like.

FIG. 4 is a view 400 of the graphical user interface in which an agreement object 410 corresponding to the research proposal is displayed. The agreement object can include a plurality of terms 420 to be negotiated. Each term 420 can include a category 422, a value 424 for the category, and status 426 (e.g., negotiation status, negotiability status, etc.). Status information can also be displayed for the agreement object 410 as a whole (not shown). In addition, in some cases, each term 420 can have a corresponding graphical user interface element 428, which when activated, changes or initiates a process to change one or more aspects of the corresponding term 420 (e.g., the categories 422, the values 424, status 426, etc.). In addition, for agreement objects having many terms 420, the terms can be grouped into categories. These categories can have corresponding category elements 430, which when activated via the graphical user interface, causes corresponding terms 420 to be displayed. In some cases, either user 310, 320 can interact with the agreement object 410 while in other cases only the initiating user 310, 320 can modify the terms 420. In some cases, the conversation panel 330 is concurrently displayed with the agreement object 410 to allow for real-time negotiation/finalization of the terms 420.

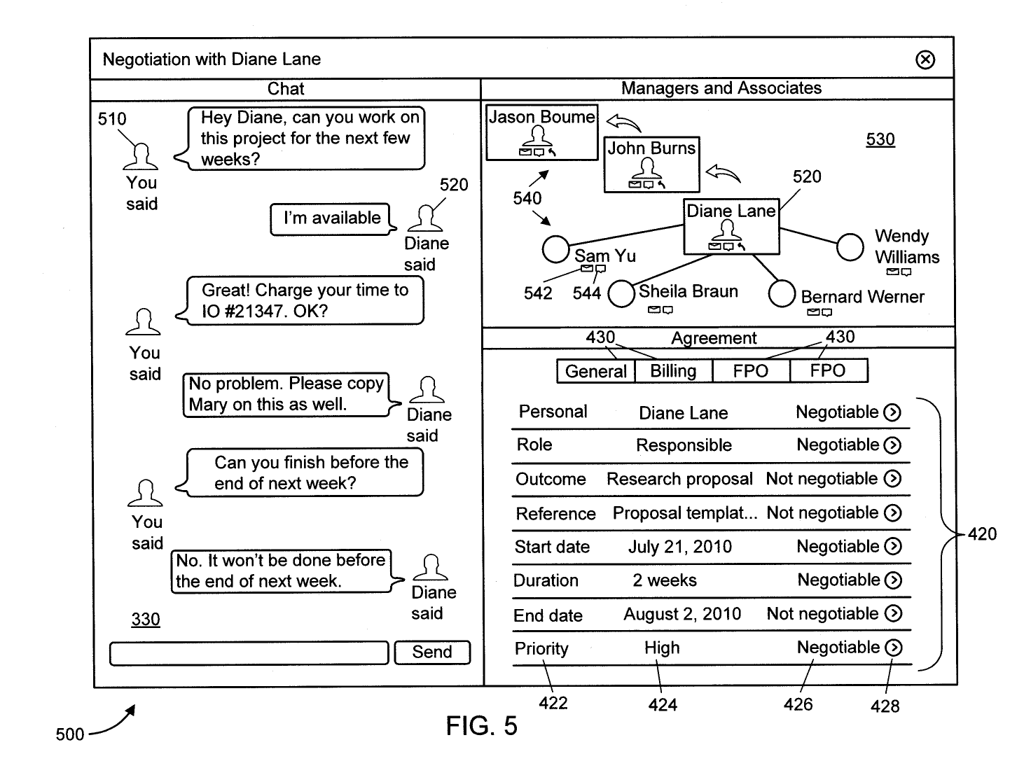

FIG. 5 is a view 500 of the graphical user interface that illustrates a conversation with differing first and second users 510, 520. In this case, additional information that is relevant to the agreement object 420 is displayed in an information panel 530. In this example, the information panel 530 includes graphical user interface elements 540 corresponding to the second user 520 as well as her managers/supervisors and associates/subordinates. The managers and associates can be displayed in an effort to identify other stakeholders whose approval or input might be required before finalizing the agreement using the agreement object 420. There can be e-mail 542 and conversation 544 elements associated with each such manager or associate in order to involve them with the negotiation process as described above.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. In addition, while many aspects of the current disclosure are directed to the use of a graphical user interface, it will be appreciated that many of the features described herein have utility separate from a graphical user interface. Other embodiments may be within the scope of the following claims.

1. A method for implementation by one or more data processors comprising:
presenting, within a graphical user interface to each of at least two users on different computing systems, an agreement object concurrently with an unstructured conversation among the at least two users, the agreement object comprising a plurality of terms for negotiation among two or more of the users;
receiving, by at least one data processor via the graphical user interface, data characterizing terms for which an agreement has been reached, wherein the presented agreement object comprises a plurality of graphical user interface elements which, when activated, generate the received data characterizing terms for which an agreement has been reached;
parsing, by at least one data processor, at least a portion of the unstructured conversation to characterize terms for which an agreement has been reached,
updating, by at least one data processor, the agreement object in the graphical user interface to reflect the terms for which an agreement has been reached; and
automatically finalizing, by at least one data processor, an agreement based on the agreement object when an agreement has been reached for each of the plurality of terms.

2. (canceled)

3. A method as in claim 1, further comprising:
parsing, by at least one data processor, at least a portion of the unstructured conversation to associate the unstructured conversation with the agreement object, wherein the agreement object is presented in response to this association.

4. A method as in claim 3, wherein the parsing uses Speech Act Theory to associate the conversation with the agreement object.

5. (canceled)

6. A method as in claim 1, wherein the parsing uses Speech Act Theory to characterize the terms for which an agreement has been reached.

7. A method as in claim 1, wherein the agreement object is one of a plurality of agreement templates made available to a user via the graphical user interface, wherein the user selects the presented agreement object.

8. A method as in claim 7, wherein the plurality of agreement templates made available to the user comprise agreement templates historically used by the user.

9. A method as in claim 7, wherein the user has a pre-defined role, wherein the plurality of available agreement templates made available to the user comprise agreement templates associated with the pre-defined role.

10. A method as in claim 7, wherein the user has a pre-defined access level, wherein the plurality of available agreement templates made available to the user comprise agreement templates associated with the pre-defined access level.

11. A method as in claim 1, wherein the unstructured conversation comprises one or more of: messaging, e-mail communications, videoconferencing, and web conferencing.

12. A method as in claim 1, wherein finalizing the agreement comprises storing, by at least one data processor, data characterizing values for each of the terms in a repository.

13. A method as in claim 1, wherein finalizing the agreement comprises displaying, by at least one data processor, data characterizing values for each of the terms in a repository.

14. A method as in claim 1, wherein finalizing the agreement comprises transmitting, by at least one data processor, the agreement to at least one entity for approval.

15. A method as in claim 1, further comprising: adding, by at least one data processor, one or more additional users to the conversation to seek approval of at least one of the terms or to obtain input regarding at least one of the terms, wherein the agreement is presented to each of the one or more additional users on a corresponding client computing system.

16. A method as in claim 1, wherein the graphical user interface comprises at least one contact graphical user interface element, which when activated, adds at least one additional user to the conversation.

17. A method as in claim 1, wherein the graphical user interface comprises at least one information graphical user interface element, which when activated, concurrently displays additional information associated with one or more of the users and/or the agreement object.

18. A method as in claim 1, wherein there are a plurality of categories of terms and each category has a corresponding category graphical user interface element, which when activated, causes associated terms to be displayed in the agreement object.

19. A method for implementation by one or more data processors comprising:
presenting, within a graphical user interface to each of at least two users on different computing systems, an unstructured conversation among two or more users;
parsing, by at least one data processor using a speech recognition algorithm, the unstructured electronic conversation between the two or more users to identify an agreement object, the agreement object comprising a plurality of terms for negotiation among two or more of the users;
concurrently display, by at least one data processor within the graphical user interface at client computing systems associated with each of the two or more users, the unstructured conversation and the agreement object;
receiving, by at least one data processor via a graphical user interface, user-generated input from at least one of the users defining a value for at least one of the plurality of terms, wherein the displayed agreement object comprises a plurality of graphical user interface elements which, when activated, generate the user-generated input defining a value for at least one of the plurality of terms;
parsing, by at least one data processor, at least a portion of the unstructured conversation to define a value for at least one of the plurality of terms;
generating, by at least one data processor based on the user-generated input and the agreement object, an agreement; and
storing, transmitting and/or displaying, by at least one data processor, the agreement.

20. A method for implementation by one or more data processors comprising:
instantiating, within a graphical user interface to each of at least two users on different computing systems, an agreement object comprising a plurality of terms for negotiation among two or more users, the agreement object being instantiated based on contextual information associated with at least one user, at least one of the terms being populated with an initial value based on contextual information associated with at least one user;
receiving, by at least one data processor, data characterizing terms for which an agreement has been reached, wherein the agreement object has a corresponding plurality of graphical user interface elements which, when activated, generate the received data characterizing terms for which an agreement has been reached;
parsing, by at least one data processor, at least a portion of the unstructured conversation to characterize terms for which an agreement has been reached;
updating, by at least one data processor, the agreement object to reflect the terms for which an agreement has been reached; and
finalizing, by at least one data processor, an agreement based on the agreement object when agreement has been reached for each of the plurality of terms.
